(19) United States
(12) Patent Application Publication
(10) Pub. No.: US 2011/0122986 A1
(43) Pub. Date: May 26, 2011

(54) METHOD OF INHIBITING ADHESION OF RADIOACTIVE SUBSTANCE AND APPARATUS INHIBITED FROM SUFFERING ADHESION THEREOF

(75) Inventors: Seiji Yamamoto, Tokyo (JP); Masami Enda, Ibaraki-Ken (JP); Hiromi Aoi, Kanagawa-Ken (JP); Yutaka Uruma, Kanagawa-Ken (JP)

(73) Assignee: Kabushiki Kaisha Toshiba, Tokyo (JP)

(21) Appl. No.: 12/674,168

(22) PCT Filed: Aug. 21, 2008
(86) PCT No.: PCT/JP2008/064940

§ 371 Date: Feb. 19, 2010

(30) Foreign Application Priority Data
Aug. 23, 2007 (JP) 2007-217541

(51) Int. Cl. G21C 9/00

(52) U.S. Cl. 376/310

(57) ABSTRACT

The present invention relates to a method and an apparatus for suppressing adhesion of a radioactive substance, capable of suppressing adhesion of the radioactive substance onto the surface of a metallic material forming a structural member in a nuclear plant. On the surface of the metallic material forming the structural member in a nuclear power generation plant, e.g., a surface 32A of a pipe 32, an adhesion-suppressing substance 34 containing titanium oxide as a titanium compound is disposed, and a part on which the adhesion-suppressing substance 34 has been formed, is held at 80° C. or higher. The adhesion-suppressing substance 34 is formed on the surface 32A of the pipe 32 by spraying a solution or a suspension liquid of the substance.

### TECHNICAL FIELD

The present invention relates to a method and an apparatus for suppressing the adhesion of radioactive substance onto the surface of metallic materials in structural members of a nuclear plant.

### BACKGROUND ART

In the light water reactor (LWR) using water as a coolant, the measure for reduction of radioactive exposure dosage to workers during periodical inspection works, a preventive maintenance construction, etc., is important. As one of such measure, a chemical decontamination is frequently applied to structural members of the nuclear reactor (such as a reactor pressure vessel, an intra-furnace structure) and piping. In the chemical decontamination, oxide films formed in the surface of metallic materials in structural members of the nuclear reactor and piping are removed by combining reduction and oxidation processes, etc., using chemicals, thereby removing radioactive substances, such as cobalt 60 and cobalt 58 existing in the clad or oxide film on the surface of a metallic material.

However, if a nuclear reactor is re-started after the decontamination, radioactive substances again adhere to the surface of the metallic material forming the nuclear reactor structural members or piping. The adhesion of radioactive substance takes place together with generation of oxide films. In the refreshed metal surface after decontamination, the growth rate of an oxide film is fast, so that the incorporation of radioactive substance occurs particularly quickly. As a result, the dose rate from the surface of the metallic material is increased again in a short cycle after the decontamination.

In order to solve this problem, it has been proposed to alternately repeat the injection of an oxidizing agent and a reducing agent to the instrument and piping of a nuclear power generation plant so as to form an oxide film on the metal material surface of the above-mentioned instrument or piping after decontamination, thereby suppressing adhesion of a radioactive substance (Patent document 1).

It is further known to have hot oxygen or ozone contact the piping of a residual heat removal system after decontamination to form an oxide film on the piping surface, thereby suppressing adhesion of a radioactive substance (Patent document 2).

It is also known to have a chemical containing iron ion contact the surface of metal members constituting a nuclear plant to form a ferrite film on the surface, thereby suppressing adhesion of a radioactive substance (Patent document 3).

Moreover, it is known to form an oxide film containing an oxide having a property of a P-type semiconductor on the surface of structural members of nuclear reactor in a nuclear power generation plant, and then depositing a catalytic substance having a property of an N-type semiconductor on the oxide film, thereby suppressing the development of stress corrosion cracking (Patent document 4).
[Patent document 1] JP-A 2004-294393
[Patent document 2] JP-A 2002-236191
[Patent document 3] JP-A 2006-38483
[Patent document 4] JP-A 2006-162522

### DISCLOSURE OF INVENTION

When an oxide film or a ferrite film is formed on the surface of the metallic material forming structural members of a nuclear power generation plant as in Patent documents 1-3, it is possible to suppress the take-in quantity of the radioactive substance accompanying the initial corrosion of the metallic material, but the take-in itself is not necessarily suppressed so that a radioactive substance is increased with time.

In Patent document 4, titanium oxide is used as a catalytic substance. However, Patent document 4 reduces corrosion potential by a pn junction of the oxide film and the catalytic substance, thereby realizing the suppression of a stress corrosion cracking development, and it does not aim at suppressing the adhesion of a radioactive substance.

In view of the above-mentioned circumstances, an object of the present invention is to provide a method and an apparatus for suppressing radioactive substance, by which adhesion of radioactive substance onto the surface of the metallic materials forming structural members of a nuclear plant can be suppressed.

The method of suppressing adhesion of radioactive substance according to the present invention, comprises: disposing a material containing a titanium compound as a substance for suppressing adhesion of radioactive substance on a surface of a metallic material forming a structural member of a nuclear plant, and holding the material at 80° C. or higher.

According to another aspect, the present invention also provides an apparatus for suppressing adhesion of radioactive substance, comprising: a structural member comprising a metallic material having a surface in a nuclear power generation plant, and a layer of substance for suppressing adhesion of radioactive substance containing a titanium compound and disposed on the surface of the metallic material, so that the structural member is in contact with primary cooling water for a nuclear reactor via the layer of the substance for suppressing adhesion of radioactive substance.

According to the present invention, the incorporation or take-in of the radioactive substance to the inside of the oxide film formed on the surface of the above-mentioned metallic material is inhibited with the substance inhibiting adhesion of radioactive substance disposed on the surface of the metallic material forming the structural member of a nuclear plant, whereby adhesion of the radioactive substance to the surface of the metallic material can be suppressed.

### BRIEF DESCRIPTION OF THE DRAWINGS

FIG. 1 is a flow diagram showing a primary cooling water system for a boiling water reactor, to which a first embodiment of the radioactive substance-adhesion suppression method and apparatus of the present invention is applied.

FIG. 2 is a sectional view showing a portion of a pipe which is a structural member in a nuclear power generation plant as shown in FIG. 1.

FIG. 3 is a graph showing test results about adhesion of radioactive substance to the pipe surface shown in FIG. 2.

FIG. 4 is a sectional view showing a portion of a pipe for illustrating a second embodiment of the radioactive substance-adhesion suppression method and apparatus of the present invention

FIG. 5 is a graph showing test results about adhesion of radioactive substance to the pipe surface shown in FIG. 4.

### BEST MODE FOR PRACTICING THE INVENTION

Hereafter, best modes for practicing the present invention are described with reference to drawings. However, the present invention is not limited to these embodiments.

### [A] First Embodiment

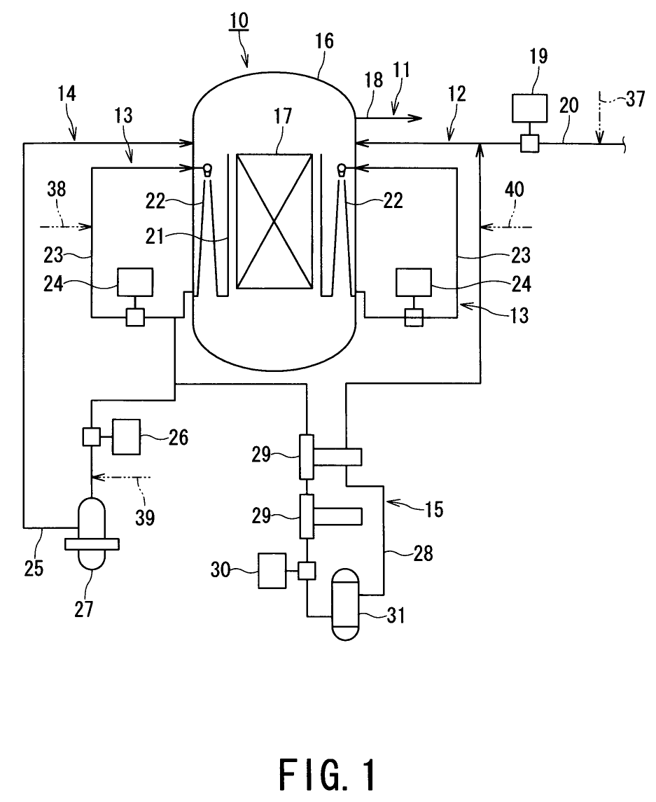

### FIG. 1-FIG. 3

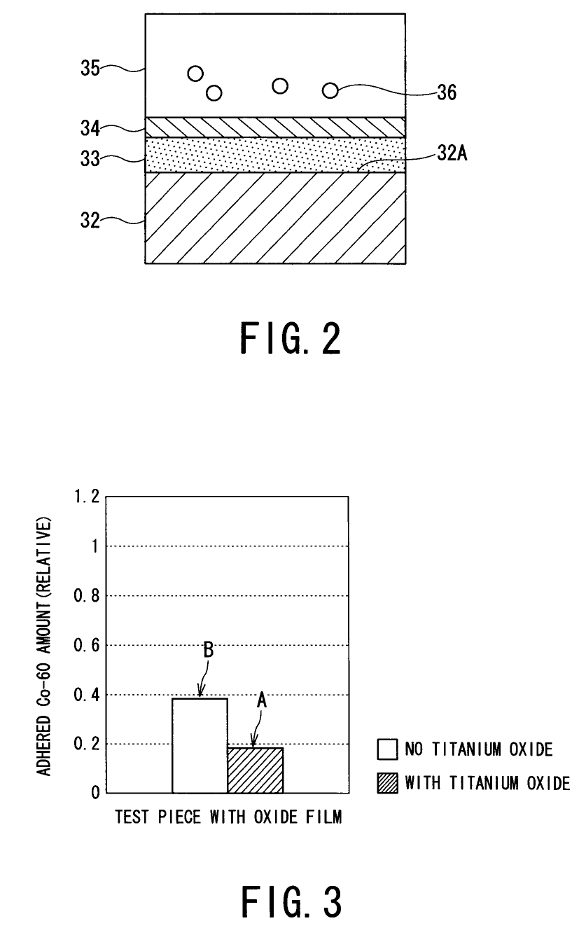

FIG. 1 is a flow diagram showing a primary cooling water system for a boiling water reactor, to which a first embodiment of the radioactive substance-adhesion suppression method and apparatus of the present invention is applied. FIG. 2 is a sectional view showing a portion of a pipe which is a structural member in a nuclear power generation plant as shown in FIG. 1.

A boiling water reactor 10 in a nuclear power generation plant is provided with a primary cooling water system including a main steam system 11, a recycled water supply system 12, a nuclear reactor recirculation system 13, a residual heat removal system 14, and a nuclear reactor coolant purification system 15, etc.

More specifically, the boiling water reactor 10 includes a reactor pressure vessel 16 and a core 17 accommodated in the vessel 16. The main steam system 11 supplies steam generated in the reactor pressure vessel 16 through the main steam system pipe 18 to a steam turbine (not shown). In the recycled water supply system 12, steam having worked after being sent to the steam turbine is condensed by a condenser (not shown) to form a recycled water, which is then recycled to the reactor pressure vessel 16 through a recycled water supply system pipe 20 equipped with a feed pump 19 and a feed water heater (not shown).

The nuclear reactor recirculation system 13 forcibly sends cooling water (coolant) into the reactor core 17. More specifically, the nuclear reactor recirculation system 13 includes a plurality of jet pumps 22 disposed in a downcomer part between a reactor core shroud 21 disposed so as to surround the reactor core 17 and the reactor pressure vessel 16, and recycle system pumps 24 disposed in re-circulation system piping 23 for elevating the pressure of the cooling water withdrawn out of the reactor pressure vessel 16. In the nuclear reactor recirculation system 13, the cooling water, of which the pressure was elevated by the re-circulation system pumps 24, is led to the jet pumps 22 which suck the cooling water therearound and forcibly send the cooling water into the lower part of the reactor core 17.

The residual heat removal system 14 includes residual heat removal system piping 25 connected to a position upstream of the re-circulation system pump 24 in the re-circulation system piping 23, and a residual heat removal system pump 26 and a heat exchanger 27 disposed in the residual heat removal system piping 25. In the residual heat removal system 14, the cooling water led to the residual heat removal system piping 25 from the nuclear reactor recirculation system 13 is cooled by the heat exchanger 27 and led to the reactor pressure vessel 16.

The nuclear reactor coolant purification system 15 includes coolant purification system piping 28 connected to a position upstream of the residual heat removal system pump 26, and a heat exchanger 29, a coolant purification system pump 30 and a filtration demineralizer 31 disposed in the coolant purification system piping 28. In the nuclear reactor coolant purification system 15, the cooling water (coolant) led to the coolant purification system piping 28 from the nuclear reactor recirculation system 13 is cooled by the heat exchanger 29 and led to and purified by the filtration demineralizer 31, and the purified cooling water is led to the recycled water supply system piping 20.

Now, the structural members in the nuclear power generation plant including, e.g., the reactor pressure vessel 16; intra-reactor structure, such as the reactor core shroud 21 and the jet pump 22; intra-reactor instruments (such as a gas-water separator and steam drier); and the instruments, such as pumps, and piping in the primary cooling water system (including the main steam system 11, the recycled water supply system 12, the nuclear reactor recirculation system 13, the residual heat removal system 14, and the nuclear reactor coolant purification system 15), are exposed to hot cooling water containing radioactive substance, so that oxide films having taken radioactive substance therein are formed on the surfaces of metallic materials forming the structural members. According to this embodiment, the incorporation or take-in of radioactive substance into this oxide film is inhibited to suppress adhesion of the radioactive substance onto the surfaces of the above-mentioned metallic materials.

For example, a pipe 32 shown in FIG. 2 is a structural member (forming a part of piping in the primary cooling water system) in a nuclear power generation plant, and primary cooling water (simply called “cooling water” hereafter) of the boiling water reactor 10 flows through inside thereof. The pipe 32 is composed of a metallic material, such as stainless steel, and an oxide film 33 is formed on the surface (inner surface) of the pipe 32.

Onto the oxide film 33, a solution or a suspension (a suspension in a particular example) of an adhesion-suppressing substance 34 capable of inhibiting adhesion of radioactive substance 36 (mentioned later) is sprayed so as to adhere onto the surface of the oxide film 33, thereby forming a layer of the adhesion-suppressing substance 34. The adhesion-suppressing substance 34 is a substance containing titanium oxide as a titanium compound. The adhesion-suppressing substance 34 is preferably formed in a layer on the entire surface of the oxide film 33 but can be formed discretely on the surface of the oxide film 33.

Then, a portion having the adhesion-suppressing substance 34 is held at 80° C. or higher within air, steam or water to enhance the tightness of the adhesion-suppressing substance 34, especially titanium oxide, and also enhance the adhesion of the adhesion-suppressing substance 34 onto the oxide film 33.

After being provided with the adhesion-suppressing substance 34, the pipe 32 is use in operation. The pipe 32 as a structural member in a nuclear power generation plant contacts primary cooling water in the nuclear reactor via the oxide film 33 and the adhesion-suppressing substance 34 or via at least the adhesion-suppressing substance 34. In this state, the pipe 32 contacts hot cooling water (nuclear reactor cooling water) 35, whereby the oxide film 33 grows and corrosion of the pipe 32 advances. The cooling water 35 contains radioactive substance 36, such as cobalt 60. In case where the oxide film 33 formed on the surface 32A of the pipe 32 is not provided with the adhesion-suppressing substance 34, radioactive substance 36 is taken into the oxide film 33 along with advance of the corrosion of the pipe 32. However, the take-in of the radioactive substance 36 to the oxide film 33 is inhibited by the formation of the adhesion-suppressing substance 34 in a tight layer as mentioned above regardless of advance of the corrosion of the pipe 32.

Now, a test result of having evaluated the effect of titanium oxide for suppressing adhesion of the cobalt 60 is shown in FIG. 3. FIG. 3 shows the results of a test wherein test pieces of SUS316L were immersed in water at 280° C. to form an oxide film thereon, and then immersed in water at 280° C. containing cobalt 60 for 500 hours. As shown in FIG. 3, the amount of adhered radioactive substance (cobalt 60) on a test piece coated with a titanium oxide (denoted by A in FIG. 3) could be reduced to about a half of the amount on a test piece with no titanium oxide (denoted by B in FIG. 3).

As described above, according to this embodiment, the take-in of radioactive substance 36 (e.g. cobalt 60) to an oxide film 33 is inhibited by the adhesion-suppressing substance 34 containing titanium oxide disposed via an oxide film 33 on the surface 32A of a pipe 32 which is a structural member of a nuclear power generation plant. As a result, adhesion of radioactive substance onto the surface 32A of the pipe 32 can be suppressed.

### [B] Second Embodiment

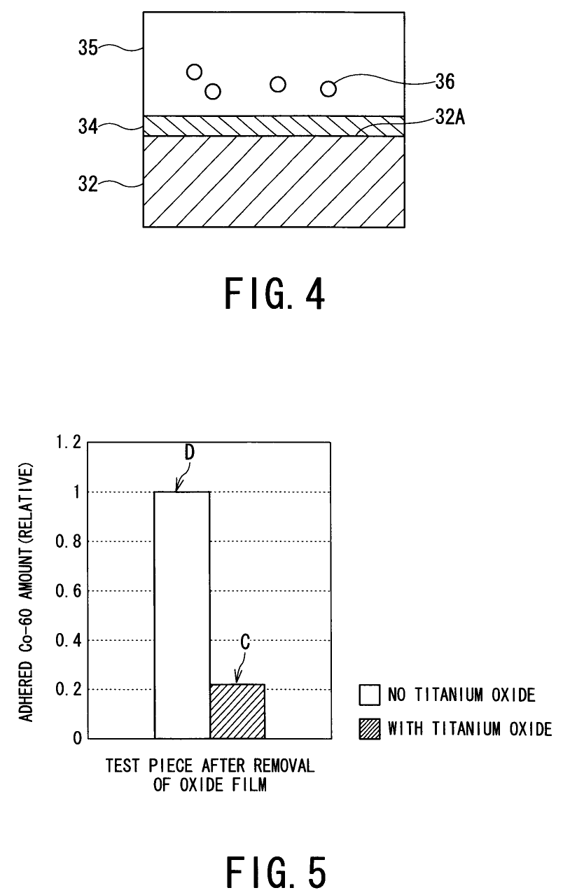

### FIG. 4, FIG. 5

FIG. 4 is a sectional view showing a portion of a pipe for illustrating a second embodiment of the radioactive substance-adhesion suppression method and apparatus of the present invention. In the second embodiment, parts identical to those in the first embodiment are denoted by identical numerals and explanation thereof is simplified or omitted.

This embodiment differs from the above first embodiment in that an oxide film 33 formed on the surface 32A of a pipe 32 is removed by a chemical decontamination treatment before spraying the suspension of an adhesion-suppressing substance 34.

Thus, in this embodiment, the oxide film 33 formed in the surface 32A of the pipe 32 is first removed by a chemical decontamination treatment. The chemical decontamination treatment is a treatment including at least one time of reductive dissolution or oxidative dissolution with a chemical, or at least one time of alternation of the above-mentioned reductive dissolution and oxidative dissolution.

Then, the adhesion-suppressing substance 34 containing titanium oxide is deposited on the surface 32A of the pipe 32 from which the oxide film 33 has been removed by the above-mentioned chemical decontamination treatment. Also in the case, the adhesion-suppressing substance 34 may be formed over the entire surface 32A of the pipe 32, or discretely on the surface 32A by spraying a suspension of the adhesion-suppressing substance 34.

Then, a portion having the adhesion-suppressing substance 34 is held at 80° C. or higher within air, steam or water to enhance the tightness of the adhesion-suppressing substance 34, especially titanium oxide, and also the adhesion of the adhesion-suppressing substance 34 onto the oxide film 33.

After being provided with the adhesion-suppressing substance 34, the pipe 32 is used in operation, and contacts hot cooling water 35 to be corroded, whereby an oxide film 33 is formed between the adhesion-suppressing substance 34 and the surface 32A of the pipe 32. Also in this case, however, the take-in of the radioactive substance 36 to the oxide film 33 formed on the surface 32A of the pipe 32 is suppressed by the formation of the adhesion-suppressing substance 34 compared with a case where the adhesion-suppressing substance 34 is absent.

Now, a test result of having evaluated the effect of titanium oxide for suppressing adhesion of the cobalt 60 is shown in FIG. 5. FIG. 5 shows the results of a test wherein test pieces of SUS316L were immersed in water at 280° C. to form an oxide film thereon, subjected to removal of the oxide film by chemical decontamination and then immersed in water at 280° C. containing cobalt 60 for 500 hours. As shown in FIG. 5, the amount of adhered cobalt 60 onto a test piece having removed the oxide film (denoted by D in FIG. 5) was increased to two times or more compared with the case of retaining the oxide film (denoted by B in FIG. 3). However, even in the case of having removed the oxide film, the amount of adhered cobalt 60 on a test piece provided with titanium oxide (denoted by C in FIG. 3) could be reduced to about ⅕ of the amount on a test piece with no titanium oxide (denoted by D in FIG. 5).

As described above, according to this embodiment, the take-in of radioactive substance 36 (e.g. cobalt 60) to an oxide film 33 is inhibited by the adhesion-suppressing substance 34 containing titanium oxide disposed via an oxide film 33 on the surface 32A of a pipe 32 which is a structural member of a nuclear power generation plant. As a result, adhesion of radioactive substance 36 onto the surface 32A of the pipe 32 can be suppressed.

Incidentally, this embodiment has been described with respect to the case where the oxide film 33 is removed from the surface 32A of the pipe 32, a similar effect is expectable even if this embodiment is applied to a pipe having no oxide film from the outset, like a fresh pipe.

### [C] Third Embodiment

### FIG. 4

The third embodiment differs from the first and second embodiments described above in that the radioactive substance adhesion-suppression method is performed at the time of inspection of a nuclear reactor, for example, at the time of the periodical inspection of the boiling water reactor 10. Also in this embodiment, parts identical to those in the first and second embodiments are denoted by identical numerals and explanation thereof is simplified or omitted.

Thus, in this embodiment, at the time of the periodical inspection of the boiling water reactor 10, decontamination treatment, such as a chemical decontamination treatment, is applied to the pipe 32 which is a structural member as described above in a nuclear power generation plant, and the oxide film 33 is removed from the surface 32A of the piping 32.

Then, the pipe 32 from which the oxide film 33 has been removed is filled with cooling water 35, into which a suspension of the adhesion-suppressing substance 34 containing titanium oxide is injected. As a result, the adhesion-suppressing substance 34 containing titanium oxide is deposited and formed on the surface 32A of the pipe 32.

Then, the temperature of the cooling water 35 in the pipe 32 is held at 80° C.-100° C. to enhance the tightness of the adhesion-suppressing substance 34, especially titanium oxide, and also enhance the adhesion of the adhesion-suppressing substance 34 (particularly titanium oxide) onto the oxide film 33.

Also in this embodiment, similarly as in the above second embodiment, the adhesion-suppressing substance 34 containing titanium oxide is formed on the surface 32A of the pipe 32 which is an example of the structural member in a nuclear power generation plant, and owing to the adhesion-suppressing substance 34, even if the pipe 32 is used in operation, the take-in of radioactive substance 36 (e.g., cobalt 60) to the oxide film 33 formed on the surface 32A of the pipe 32 can be inhibited. As a result, it becomes possible suppress the adhesion of the radioactive substance 36 to the surfaces of the metallic materials of the above-mentioned structural members, such as the surface 32A of the pipe 32, exposed to primary cooling water or steam thereof in the boiling water reactor 10.

### [D] Fourth Embodiment

### FIG. 1

The fourth embodiment differs from the first to third embodiments described above in that the method and apparatus for suppressing adhesion of radioactive substance are operated during the time of start-up, stopping or operation of a nuclear reactor. Also in this embodiment, parts identical to those in the first and second embodiments are denoted by identical numerals and explanation thereof is simplified or omitted.

Thus, in this embodiment, the apparatus system of FIG. 1 is provided with a 1st injection point 37 upstream of the feed pump 19 in the recycled water supply system piping 20, a 2nd injection point 38 downstream of the re-circulation-system-pump 24 in the re-circulation system piping 23, a 3rd injection point 39 downstream of the residual-heat-removal-system-pump 26 in the residual heat removal system piping 25, and a 4th injection point 40 downstream of the coolant purification system pump 30 and the filtration demineralizer 31 in the coolant purification system piping 28, respectively, as denoted by two point-and-dash lines. A suspension of the adhesion-suppressing substance 34 containing titanium oxide is injected from at least one of the 1st injection point 37, the 2nd injection point 38, the 3rd injection point 39 and the 4th injection point 40 described above by means of an injection pump (not shown), etc. during the time of start-up, stopping or operation of the nuclear reactor 10.

The injected adhesion-suppressing substance 34 is injected into the cooling water of the primary cooling water system (the recycled water supply system 12, the nuclear reactor recirculation system 13, the residual heat removal system 14, or the nuclear reactor coolant purification system 15) in which a selected one of the injection points 37-40 exists, to reach all the primary cooling water systems including the boiling water reactor 10 along with the cooling water, and is caused to adhere and disposed on the surface 32A of those structural members, such as pipe 32, directly or via the oxide film 33. In the primary cooling water system, the temperature of cooling water is controlled at 100° C.-200° C., so that the tightness of the adhesion-suppressing substance 34 disposed on the surface 32A of the pipe 32 directly or via the oxide film 33 is improved, and the adhesion to the surface 32A or the oxide film 33 of the pipe 32 is improved.

The adhesion-suppressing substance 34 is directly formed on the surface 32A of the pipe 32, in the case where the pipe 32 is a fresh pipe or the oxide film 33 has been removed by decontamination from the surface 32A of the pipe 32.

Also in this embodiment, similarly as in the above first and second embodiments, the adhesion-suppressing substance 34 containing titanium oxide is formed on the surface 32A of the pipe 32 which is an example of the structural member in a nuclear power generation plant, and owing to the adhesion-suppressing substance 34, the take-in of radioactive substance 36 (e.g., cobalt 60) to the oxide film 33 formed on the surface 32A of the pipe 32 can be inhibited. As a result, it becomes possible to suppress the adhesion of the radioactive substance 36 to the surfaces of the metallic materials of the above-mentioned structural members, such as the surface 32A of the pipe 32.

Incidentally, while an example of application to the boiling water reactor (BWR) equipped with an external recycle system outside an nuclear reactor has been described above in each embodiment of the present invention, the present invention can also be applied to the improved type boiling water reactor (ABWR) equipped with an internal recycle system inside the reactor, and can also be applied to the pressurized water reactor (PWR) with a light water reactor. In a pressurized water reactor, the reactor pressure vessel is replaced by a reactor vessel, and an intra-reactor structure, a core vessel, a control rod cluster, etc., are disposed in the reactor vessel.

1. A method of suppressing adhesion of radioactive substance, comprising: disposing a material containing a titanium compound as a substance for suppressing adhesion of radioactive substance on a surface of a metallic material forming a structural member of a nuclear plant, and holding the material at 80° C. or higher.

2. The radioactive substance-adhesion suppression method according to claim 1, wherein the substance for suppressing adhesion of radioactive substance comprises titanium oxide.

3. The radioactive substance-adhesion suppression method according to claim 1, wherein the substance for suppressing adhesion of radioactive substance is disposed by spraying a solution or a suspension liquid of the substance on the surface of the metallic material.

4. The radioactive substance-adhesion suppression method according to claim 1, wherein the substance for suppressing adhesion of radioactive substance is disposed on the surface of a metallic material, after removing an oxide from the surface of the metallic material.

5. The radioactive substance-adhesion suppression method according to claim 4, wherein the oxide is chemically removed by reductive dissolution or oxidative dissolution, or by alternation of reductive dissolution and oxidative dissolution.

6. The radioactive substance-adhesion suppression method according to claim 1, wherein the substance for suppressing adhesion of radioactive substance is disposed on the surface of a metallic material by first removing an oxide from the surface of the metallic material at a time of inspection of a nuclear reactor, and then injecting the substance into cooling water and controlling the cooling water at a temperature of 80° C. to 100° C.

7. The radioactive substance-adhesion suppression method according to claim 1, wherein the substance for suppressing adhesion of radioactive substance is disposed on the surface of a metallic material by injecting the substance in cooling water for a nuclear reactor at a time of start-up, stopping or operation of the nuclear reactor.

8. The radioactive substance-adhesion suppression method according to claim 7, wherein the substance for suppressing adhesion of radioactive substance is disposed on the surface of the metallic material by controlling the cooling water for the nuclear reactor at a temperature of 100° C. to 200° C.

9. An apparatus for suppressing adhesion of radioactive substance, comprising:
a structural member comprising a metallic material having a surface in a nuclear power generation plant, and a layer of substance for suppressing adhesion of radioactive substance containing a titanium compound and disposed in a layer on the surface of the metallic material, so that the structural member is in contact with primary cooling water for a nuclear reactor via the layer of the substance for suppressing adhesion of radioactive substance.

10. The radioactive substance-adhesion suppression apparatus according to claim 9, wherein the structural member in the nuclear power generation plant comprises an intra-reactor structure, an intra-reactor instrument, a primary cooling water system instrument, and primary cooling water system piping of a light water reactor.

11. The radioactive substance-adhesion suppression apparatus according to claim 9, wherein the substance for suppressing adhesion of radioactive substance is disposed in a layer directly or via an oxide film on the surface of the metallic material forming the structural member in a nuclear power generation plant.
